(19) United States
(12) Patent Application Publication
(10) Pub. No.: US 2003/0014225 A1
(43) Pub. Date: Jan. 16, 2003

(54) Thermodynamic simulated annealing schedule for combinatorial optimization problems

(76) Inventor: Juan Francisco De Vicente, S. S. Reyes (ES)

Correspondence Address: JUAN FRANCISCO DE VICENTE ALBENDEA, AVDA. PONTEVEDRA, 10 ESC. DCHA. 2 A, S. S. REYES MADRID, 28700, ES

(21) Appl. No.: 09/682,043

(22) Filed: Jul. 13, 2001

(51) Int. Cl. G06F 17/10

(52) U.S. Cl. 703/2

(57) ABSTRACT

Combinatorial Optimization problems arise in different areas of engineering. Simulated Annealing is a useful combinatorial optimization method. Nevertheless, to achieve high performance with Simulated Annealing costly experimental studies in fine tuning the annealing schedule are required. Present disclosure provide a Thermodynamic Simulated Annealing Schedule (TSAS) to ease simulated annealing application. TSAS is derived from both Thermodynamics and Information Theory. TSAS adapts to the problem and cost function while providing high performance.

### BACKGROUND OF THE INVENTION

Combinatorial Optimization

In many areas of engineering arise Combinatorial Optimization (CO) problems (e.g., industrial control, integrated circuit design, artificial intelligence, chemical processes, etc). In CO, a solution of minimum cost must be found among a large number of possible configurations. The set of such configurations is denominated solution space. Usually, the solution space grows exponentially with the size of the problem, and the exploration of the whole solution space becomes unapproachable for moderate problem instance sizes. Therefore, a discriminatory search must be performed to approximate to the optimal solution.

There are different methods to treat Combinatorial Optimization problems. A main classification can be established between general and specific methods. General methods are intended for a wide spectrum of problems, while specific ones are problem oriented. In this work, we are interested in general Combinatorial Optimization methods. Among them, local search or iterative improvement is widely aapplied. The main idea consists of performing local transformations from an initial configuration. Transformations with cost-decrements are accepted, while transformations with an increment in the cost are rejected. The main drawback of the basic local search method is that the optimization usually gets stuck at a local minimum. There are other general methods that allow the search to escape from local minima. Among them, Simulated Annealing (SA) is one of the most successful methods. Unlike the basic local search, SA is a probabilistic combinatorial optimization method. Its probabilistic nature allows SA to escape from local minima.

Simulated Annealing

SA is based on the analogy between combinatorial optimization problems and the problem of determining the lowest-energy ground state of solids. The annealing is a widespread process performed in the industry to achieve this goal. A similar process to the annealing of solids can be simulated to solving combinatorial optimization problems. The simulated annealing process consists of first melting the system being optimized at a high effective temperature, then lowering the temperature by slow stages until system freezes and no further changes occur. SA is carried out in practice by slight modification of the local search method. Thus, SA local transformations decreasing the cost are always accepted, but unlike common local search, SA transformations with an increment in the cost are accepted according to a probability based on the Boltzmannfactor

exp(−ΔC/T)

where Δ C is the cost variation and T is a parameter denominated temperature.

Since an annealing process is carried out, a high initial value of the temperature must be selected, and then the temperature is lowered slowly. Thus, the simulation must proceed long enough at each temperature for the system to reach a steady state. The sequence of temperatures and the number of solutions attempted to reach equilibrium at each temperature can be considered the annealing schedule. The annealing schedule is a key issue for SA success. There are some theoretical studies proving the asymptotic convergence of the SA to the optimal solution for determined annealing schedules. Nevertheless, such asymptotic requirement predicts infinite transformations to guarantee the global optimum solution. In practice, real life problems are time constrained, and a common goal is to reach good solutions within the available time. So, fast annealing schedules are usually applied as Fast Annealing, or the exponential temperature decrease given by

Tᵢ₊₁=aTᵢ with 0<a<1

Although SA has been successfully applied to many combinatorial optimization problems, a large number of empirical studies are required in parameter adjustments. Some attempts to automatically determine the annealing schedule have also been carried out. For example, Adaptive Simulated Annealing proposes an exponential formula for the annealing schedule depending on the dimension of the problem. Also, in Generalized Simulated Annealing the temperature depends on the cost of the solution explored. Although some of these variations of SA produce excellent results, they usually require some previous knowledge of the problem. Above considerations make SA a method whose best results depend upon the skillsor experience of practitioners.

Thermodynamics

Classic Thermodynamics focuses on energetic transformations of macroscopic physical phenomena related to heat and temperature. Its field of application is restricted to equilibrium states and transformations represented by series of equilibrium states. A system is regarded in thermodynamic equilibrium, when it achieves a state where the macroscopic variables that characterize the system reach constant values.

Thermodynamics studies physical phenomena from the macroscopic point of view based on observable properties. A system is defined as a part of the space and its content, and the description of the system state is performed by a set of macroscopic properties denominated variables or thermodynamic coordinates. The set of independent variables needed to characterize the system is denominated state variables. The rest of variables of the system can be represented as a function of them. A function that can be expressed by means of state variables is denominated state function of the system, e.g. internal energy, entropy, etc. The variation of a state function only depends on the initial and final states, and it does not depend on the process connecting the two states.

A system undergoes a process or thermodynamic transformation when any variable characterizing the system changes. The initial and final states are regarded in equilibrium. A process is denominated quasistatic when the intermediate states are also equilibrium states. The process is reversible when a slight variation on external conditions makes possible, to reverse a quasiestatic transformation. And the process is irreversible when the intermediate states are not equilibrium states. The efficiency of a reversible transformation improves any other transformation performed irreversibly.

Thermodynamics rests on three laws from which all thermodynamic rules are derived. We will be interested in the first and second laws. The first law of thermodynamics is expressed as

ΔU=Q−W

where ΔU is the internal energy variation, Q the interchanged heat, and W the work performed in a transformation. The second law determines the direction of thermodynamic processes and the equilibrium state of physical systems. The mathematical expression of the second law applied to a reversible transformation performed at temperature T is given by

ΔS=Q_{R}/T

where ΔS is the entropy variation, and Q_{R} the heat nterchanged

### SUMMARY OF THE INVENTION

In many areas of sciences and engineering arise Combinatorial Optimization (CO) problems. Simulated Annealing (SA) is a general method emerged to solving a large diversity of CO problems. In spite of SA success, it is a method whose best results depend upon the experience of practitioners. Thus, one of key issue of SA is the temperature schedule. Usually a large number of empirical studies are required in fine-tuning the temperature schedule parameters.

The present disclosure contains the Thermodynamic Simulated Annealing Schedule (TSAS) method. Such method provides a thermodynamic temperature schedule for Simulated Annealing. In TSAS, the temperature is updated all along to the ratio between the accumulated cost and entropy variations. The accumulated entropy variation is measured as the sum over all previous Simulated Annealing iterations of the natural logarithm of the probabilities of acceptance applied.

TSAS is derived from the application of the first and second thermodynamic laws applied to reversible processes. A key feature of reversible processes is just that intermediate states of a transformation are also equilibrium states. Moreover, since the efficiency of a reversible transformation improves any other transformation performed irreversibly, a cooling of the system performed reversibly theoretically achieves the maximum efficiency. This method allows simulated annealing algorithm to perform a cooling close to equilibrium missing out the need of expensive experimental adjustments. TSAS present interesting adaptive features while providing high quality solutions.

### BRIEF DESCRIPTION OF DRAWINGS

FIG. 1 compares the optimization development for an instance of the integrated circuit placement problem with:

a) the common simulated annealing schedule Tₖ₊₁=aTₖ with 0<a<1

b) Thermodynamic Simulated Annealing Schedule

### DETAILED DESCRIPTION OF THE INVENTION

Thermodynamic Simulated Annealing Schedule

One of the theoretical basis of SA consists of reaching equilibrium at each temperature. In order to achieve this goal, the annealing schedule of SA goes along a sequence of temperatures for cooling the system, while a number of rearrangements are attempted to recover equilibrium at each one (i.e., the system does not achieve equilibrium if temperature is lowered too quickly). A main concern of SA practitioners is how slowly it should be the cooling to avoid the search gets stuck in local minima. That is, how large temperature steps should be, and how many moves should be performed to recover equilibrium at each temperature. Both parameters, the magnitude of temperature drops, and the number of movements performed at each temperature are usually adjusted experimentally for each cost function.

Thermodynamic Simulated Annealing Schedule (TSAS) provides an alternative method to perform the cooling close to equilibrium missing out on experimental adjustments. TSAS is derived from the first and second laws of Thermodynamics applied to reversible processes. A key feature of reversible processes is just that intermediate states of a transformation are also equilibrium states. In the rest of this section, we deduce the annealing schedule subjected to the optimization process is reversible.

On one hand, the first law of thermodynamics for systems that only interchange heat with surroundings and do not perform work takes the form

U_{B}−U_{A}=Q

On the other hand, the second law of thermodynamics for a reversible process performed between two states at temperature T can be expressed as

S_{B}−S_{A}=Q_{R}/T

Therefore, a reversible process (suffered by a system at temperature T) that only interchange heat with surroundings should meet

S_{B}−S_{A}=(U_{B}−U_{A})/T

Finding T and making the equivalence between Internal Energy (U) and Cost of a solution (C) for combinatorial optimization problems we have

T=(C_{B}−C_{A})/(S_{B}−S_{A}) (Eq. 1)

Thus, the value of T given by Eq. 1 ensures that the transformation between the states A and B has been performed reversibly. Now, we are going to find the expression for the entropy variation of Eq. 1.

According to the information theory, the information (ΔI) obtained in the reception of a message of probability Pᵢ is equal to

ΔI=−In(Pᵢ)

In the same way, the Entropy variation due to a reversible transformation between the states A and B will be

S_{B}−S_{A}=In(P_{AB})

Now, assume a reversible transformation between the states A and B performed in k iterations. Let Pᵢ be the probability of acceptance for the transformation attempted at the iteration i. Then

$${P}_{AB} = {\prod }_{i = 1}^{k} {P}_{i} \\ Therefore \\ {S}_{B} - {S}_{A} = ln {\prod }_{i = 1}^{k} {P}_{i} \\ or \\ {S}_{B} - {S}_{A} = {\prod }_{i = 1}^{κ} ln {P}_{i} \qquad ( Eq . 2 )$$

Substituting the entropy variation (Eq. 2) and the cost variation in Eq. 1, we have the thermodynamic annealing schedule given by

$${T}_{k + 1} = {k}_{a} {C}_{0} - \frac{{C}_{k}}{{\sum }_{i = 1}^{k} ln ( {P}_{i} )} \qquad ( Eq . 3 )$$

where C₀ is the initial cost, Cₖ the current cost, and Kₐ is a parameter introduced to control the run-time/quality tradeoff. Note that, to avoid singularities and force the minimization, this equation must only be applied when both, Cₖ<C₀ and the entropy variation is different from zero. Otherwise the initial temperature T₀ must be applied. We can also distinguish two functional modes: adaptive and normal. In adaptive mode (that must be applied when the search starts from a halfway solution) the initial temperature is set to zero. In normal mode the initial temperature can be selected to a non-zero value. This mode can be applied when the search starts from a random configuration.

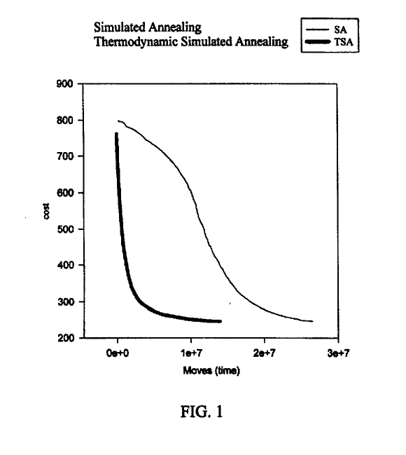

FIG. 1 shows an example of the optimization development with Thermodynamic Simulated Annealing Schedule with respect to a common Simulated Annealing schedule (Tᵢ₊₁=aT ᵢ0<a<1) for the integrated circuit placement problem. Note that the cost with TSAS drops faster while preserving the solution quality.

Finally, we can summarize saying that Thermodynamic Simulated Annealing Schedule is an annealing schedule that adapts automatically to different problems and cost functions while providing high performance.

### References

U.S. Patent Documents

U.S. Pat. No. 5,745,735 April 1998 Cohn, et al.

U.S. Pat. No. 6,088,519 May 1998 Koford

U.S. Pat. No. 5,875,117 April 1996 Edwin

U.S. Pat. No. 5,568,381 October 1996 Hara, et al.

U.S. Pat. No. 6,185,724 December 1997 Ochotta

U.S. Pat, No. 4,495,559 January 1985 Gelatt

Other References

S. Kirkpatric, C. D. Gelatt, and M. P. Vecchi, “Optimization by simulated annealing,” Science, vol. 220, no. 4598, pp. 671-680, May 1983.

D. F. Wong, H. W. Leong, C. L. Liu, “Simulated Annealing for VLSI Desing”, Kluwer Academic Publishers, 1988.

R.H. J. M. Otten, L. P. P. P. van Ginneken, “The Annealing Algorithm”, Kluwer, 1989.

B. Hajec, “Cooling schedules for optimal annealing”, Mathematics of Operations Research 13, 1988, pp. 311-329.

E. Aarts, J. Korst, “Simulated Annealing and Boltzmann Machines, A Stochastic Approach to Combinatorial Optimization and Neural Compupting”, John Wiley & Sons, 1989.

S. Geman and D. Geman, “Stochastic relaxation, Gibbs distribution and the Bayesian restoration in images”, IEEE Trans. Patt. Anal. Mac. Int. 6 (6), 721-741, 1984.

H. Szu, R. Hartley, “Fast simulated annealing”, Physics Letters A 122,1987, pp. 157-162.

M. E. Johnson I. O. Bohachevsky, M. L. Stein, “Generalized simulated annealing for function optimization”, Technometrics, 28(3), 1986.L. lngber, “Adaptive simulated annealing (ASA): Lesson learned,” Control and Cybernetics, 25, pp. 33-54 (1996).

C. E. Shannon, “A mathematical theory of communication”, I & II. Bell Syst. Tech. J., 27, pp. 379-423,623-656, 1948.

V. Betz and J. Rose, “VPR: A new Packing, Placement and Routing Tools for FPGA Research”, International Workshop on Field Programmable Logic and Applications 1997.

C. Sechen, and A. Sangiovanni-Vincentelli, “The TimberWolf placement and routing package,” in Proc. Custom Integrated Circuit Conf. ( Rochester, N.Y.), 1984, pp. 522-527.

What is claimed is:

1. A Thermodynamic Simulated Annealing Schedule to ease Simulated Annealing (SA) application in solving combinatorial optimization problems, where the temperature is updated after each local transformation as:
a) the initial temperature while either the global cost variation is positive or all previous probabilities of acceptance are equal to one.
b) proportional to the global cost-decrement achieved at this moment divided by the sum over all previous iterations of the natural logarithm of the applied probabilities of acceptance.
